(19) United States
(12) Patent Application Publication
(10) Pub. No.: US 2007/0160896 A1
(43) Pub. Date: Jul. 12, 2007

(54) Plasmonic fuel cell

(75) Inventors: Henryk Malak, Ellicott City, MD (US); Christopher A. Ettore, Boston, MA (US)

Correspondence Address: Henryk Malak, 8444 High Ridge Road, Elicott City, MD, 21043, US

(73) Assignee: American Environmental Systems, Inc

(21) Appl. No.: 11/327,976

(22) Filed: Jan. 9, 2006

(51) Int. Cl. H01M 4/86

(52) U.S. Cl. 429/40; 429/44

(57) ABSTRACT

The invention discloses novel solutions in fuel cell technology that are based upon advances in nanotechnology. The solutions relate to the use of an embedded plurality of nanostructures in a fuel cell, to the nanostructures micro- to nano-positions with respect to each other, to tuned nanostructure properties to energy sources and nanotechnology effects. Such proposed solutions lead to more effective electrochemical reactions, to better generation/diffusion of ions, electrons, and reaction products at the reaction sites, to better “burning” of fuels, to reduced fuel cross-over effects, to more robust the fuel cell, to significant increased production of electricity in the proposed fuel cells, and to other beneficial effects.

### CROSS REFERENCE TO RELATED APPLICATIONS

This application claims the priority date of the U.S. provisional patent application Ser. No. XX/XXXX filed Dec. 3, 2005 entitled “Plasmonic Fuel Cell”, each of which is incorporated by reference herein in their entirety.

### STATEMENT REGARDING FEDERALLY SPONSORED RESEARCH

There is NO claim for federal support in research or development of this product.

### FIELD OF THE INVENTION

This invention is related to improvements of fuel cell by nanotechnology effects and materials.

### BACKGROUND OF THE INVENTION

Since electrical production in fuel cells is highly efficient relative to other alternatives, they are seriously considered as realistic alternative, environmentally-sound energy sources.

In the last few years, enormous progress has been made in fuel cell technology. However, there are still many limitations and this progress does not resolve problems in fuel cell technology related to their low performance, such as those described below (but are not limited to them): low reactivity between the electrode/catalyst and the liquid or gas fuels, crossover of liquid and gaseous fuels through the ion conductive membrane-electrolyte, excessively high or low affinities of electrochemical reaction products to the electrode/catalyst and/or membrane-electrolyte, limitation to the use of fuels such as methanol and oxygen/air in the fuel cells over the more environmentally-friendly and cost-effective use of other fuels such as ethanol, alcohols of higher order, and peroxides, carbon monoxide formation in fuel cells, and corrosion of the fuel cell components.

To address these limitations, new breakthrough inventions are needed. The most successful inventions will be based upon the multi-disciplinary use of advances in numerous scientific and technology fields.

For example, in current fuel cell development, there is a need for different catalytic materials other than platinum that possess increased catalytic reactivity with fuels and costs less. However, there are physical and chemical limitations of the catalytic reactivity of many materials, and for these reasons, it is difficult to develop a material with a significantly higher catalytic reactivity than those currently utilized. One of the current approaches of enhancing the catalytic reactivity of materials in fuel cells is to make them smaller thus shrinking these materials to nanometer-sizes (nano-sizes). This approach takes advantage of an increased surface area of catalyst materials that is directly proportional to catalytic reactivity. However, there is a limitation of just how small particles can become and still remain useful in fuel cell technology. Additionally, this surface area versus catalytic reactivity effect is linear and will not lead to a breakthrough in catalyst technology. Therefore, new non-conventional approaches are needed in catalyst technology to enhance catalyst reactivity by several orders of magnitude. Similar breakthroughs are needed in electrode materials and membrane-electrolyte materials, such as ion conductive materials, electron conductive materials, and other doped materials. The outcome of these improvement efforts should dramatically shift the electrical output towards an almost completely efficient level in fuel cells.

Other breakthroughs are also needed in fuel cell technology in order to promote complete “burning” of fuels in fuel cells. There is a great need for the use of propane, ethanol, alcohols of higher order, and/or water (but are not limited to them) as fuels in fuel cells. Again, a new invention or several new combined inventions are needed to improve fuel cell technology.

### SUMMARY OF THE INVENTION

The invention discloses novel solutions in fuel cell technology that are based upon advances in nanotechnology. The solutions relate to the use of an embedded plurality of nanostructures in a fuel cell, to the nanostructures micro- to nano-positions with respect to each other, to tuned nanostructure properties to energy sources and nanotechnology effects. Such proposed solutions lead to more effective electrochemical reactions, better generation/diffusion of ions, electrons, and reaction products at the reaction sites, to better “burning” of fuels, to reduced fuel cross-over effects, to more robust the fuel cell, to significantly increased production of electricity in the proposed fuel cells, and to other beneficial effects.

One of the embodiments of the invention describes the use of nanotechnology effects such as a surface plasmon resonance (SPR) enhancement and other nanotechnology enhancements. SPR in the nanostructures can provide an enormous enhancement of the nanostructure's reactivity to fuels. Such reactivity enhancement will produce more electricity in the fuel cells and will also promote better or complete “burning” processes, which leads to more efficient and safer fuel cells.

The invention considers the generation of SPR in the nanostructures by the electrochemical reactions occurring in fuel cells or by other internal and/or external energy sources. The electrochemical reactions are usually associated with the generation of electromagnetic radiation and heat that can be used for SPR generation and the other nanotechnology effects. The internal and/or external energy sources such as electromagnetic radiation, thermal, sonic, magnetic, electrochemical, and other energy sources can be powered by the fuel cell itself or by external sources.

In one of the embodiments of the invention it is proposed that SPR enhancement occurs at a reaction site where a luminescent probe is also located. The probe will enhance chemiluminescence produced by the electrochemical reactions by several orders of magnitude. The enhanced chemiluminescence will then be used to generate SPR in nanostructures that will increase their interaction with the fuel.

The invention also discloses fuel cells in which SPR and other nanotechnology effects are generated by the movement of fuel through the micro-/nano-porous/capillary structures of the electrodes. The interaction of fuels with such structures can be so intense as to even provide a separation of electrons and ions in water, which then can be used in the production of electricity in fuel cells. It is also proposed in the invention that an additional forcing of fuel movement through the structures will further enhance electrochemical reactions in the fuel cells due to better separation of fuel molecules and other effects.

Another embodiment of the invention discloses the use of the fuel enriched by the nanostructures. The enriching of fuels is particularly important for ethanol and higher order alcohols, but is not limited to them, where the “burning” processes of these fuels are not complete. The nanostructures in the fuel can have catalytic/ionic/electron properties activated at the reaction side in the electrodes, where SPR and other nanotechnology effects are present.

The invention also describes improvements in fuel cells related to crossover of the fuel through the membrane-electrolyte or excessive accumulation of the reaction products at the membrane-electrolyte site and the electrode sites. It is proposed to utilize the induced hydrophobicity and/or hydrophilicity of the embedded plurality of the nanostructures to mitigate these problems.

### BRIEF DESCRIPTION OF THE DRAWINGS

FIG. 1 shows a random distribution of the nanostructures with respect to each other in an electrode.

FIG. 2 shows a fixed distribution of the nanostructures with respect to each other in an electrode.

FIG. 3 shows a fuel cell in which carbon nanotubes are used for fuel delivery.

FIG. 4 shows a fuel cell in which fuel delivery is controlled by the voltage.

FIGS. 5a, 5b, and 5c show the carbon nanotubes with other attached nanostructures to inner walls or to external walls, or to both the internal and external walls, respectively.

FIG. 6 shows carbon nanotubes and other nanostructures embedded into an electrode.

FIG. 7a and 7b show capillaries built into the electrode based upon the random and fixed (composite) distributions of nanostructures, respectively.

FIG. 8 shows a reaction site where a luminescent probe and other nanostructures are located.

FIG. 9 shows the nanostructures covering an anode site and cathode site of a membrane.

FIG. 10 shows a fuel cell in which a membrane is illuminated by electromagnetic radiation (LED) that causes the generation of SPR and other effects in the membrane.

### DETAILED DESCRIPTION OF PREFERRED EMBODIMENTS

1. Abbreviations.

SPR—surface plasmon resonance
LED—light emitting diode, which includes an inorganic, organic and supper luminescent diodes
Electron-Hole pair effect—the effect where energy creates electron and hole pairs in the material, which lead to electron and hole recombination associated with emission of energy.
   2. Exemplary Embodiments

The invention discloses novel solutions in fuel cell technology that are based upon advances in nanotechnology. The solutions relate to the use of an embedded plurality of nanostructures in a fuel cell, to the nanostructures micro- to nano-positions with respect to each other, to tuned nanostructure properties to energy sources and nanotechnology effects. Such proposed solutions lead to more effective electrochemical reactions, to better generation/diffusion of ions, electrons, and reaction products at the reaction sites, to better “burning” of fuels, to reduced fuel cross-over effects, to more robust the fuel cell, to significant increased production of electricity in the proposed fuel cells, and to other beneficial effects.

The invention considers the use of the embedded plurality of nanostructures of different sizes, shapes, and materials that have relevant impact on their properties and functions in the fuel cell. Therefore, the nanostructures in the proposed fuel cell are especially designed to provide enhanced interactions with a fuel and fuel products in addition to the other interactions with energy sources originating within the fuel cell or powered externally.

Materials for the nanostructures are selected from the group of materials: noble metals, non-noble metals, metal alloys, metal oxides, combinations of metal alloys with metal oxides, non-metallic electron conductive materials, non-metallic semiconductive materials, ion conductive materials, carbon nanotubes, silicates, chemical substances, luminescent probes, but are not limited to them.

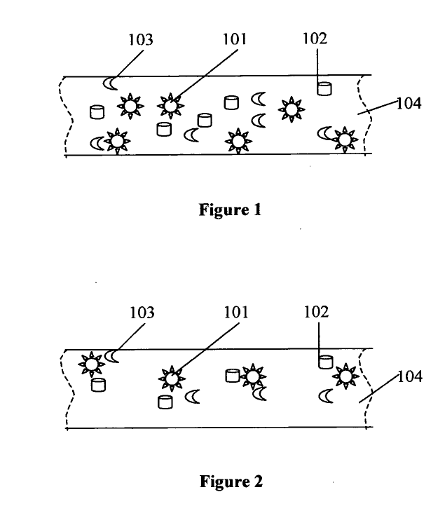

The proposed arrangements of the embedded plurality of nanostructures in an electrode 104 are shown in FIG. 1 and FIG. 2, wherein a catalyst 101, ion conductor 102 and electron conductor 103 are arranged randomly or predetermined in the electrode 104, respectively. The advantage of the predetermined arrangement is that, at a reaction site, the catalyst, electron and ion conductors, and other selected nanostructures are always present promoting increased separation of electrons and ions and fuel reaction products. In the random arrangement in order to fulfill the requirements, higher concentrations of each nanostructure are required. Both arrangements of the nanostructures in any component of the fuel cell are anticipated in the invention as well as varying or constant concentrations of the nanostructures across the components of the fuel cell.

The embedded nanostructures may have a function or multiple functions in the fuel cells such as (but are not limited to them): hydrogen storage, fuel delivery, hydrophilicity, hydrophobicity, electron conductor, catalyst, ion conductor, luminescent, luminescence enhancer, plasmon generation enhancer, electro-hole pairs generation enhancer. It is proposed that the function or multiple functions of the nanostructures are stimulated or controlled by the energy sources originating within the fuel cell and/or powered externally.

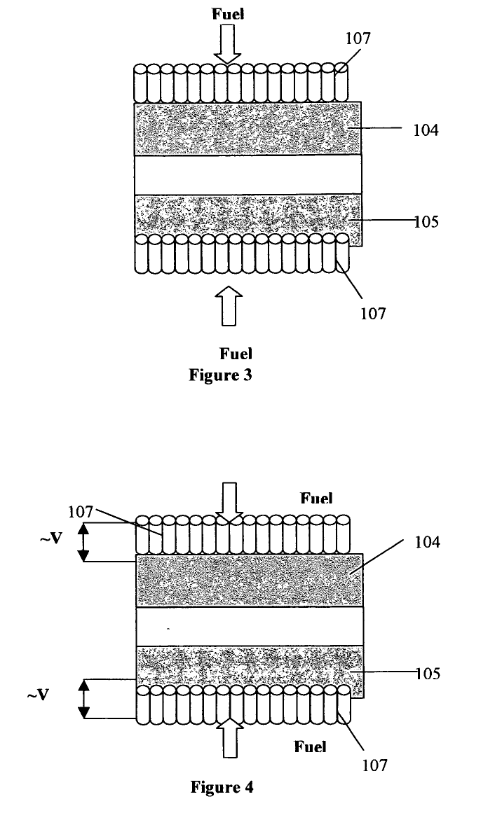

One of the embodiments discloses the use of carbon nanotubes 107 for delivering fuels to an anode electrode 104 and cathode electrode 105, as it is shown in FIG. 3. Carbon nanotubes may accelerate movement of fuel, like “jet nozzles”, causing better separation of fuel molecules that can increase the reactivity of fuels with electrodes and lead to production of more electricity by the fuel cell. It is further proposed in the invention that fuel delivered through carbon nanotubes or other nanostructures can be additionally controlled by an electrical potential (voltage) imposed on them. Higher voltage can increase the fuel delivery to the electrodes and lower voltage or an opposite polarity voltage can reduce or stop the fuel delivery to the electrodes. An example of fuel delivery in the fuel cell controlled by the voltage is shown in FIG. 4. The described method of fuel delivery control is proposed to be extended to carbon nanotubes or other nanostructures embedded into the electrodes and membrane in which controllable changes of voltage can lead to improved performance of the fuel cell, e.g. increased current production, controlled current production, lower fuel crossover, but not limited to them.

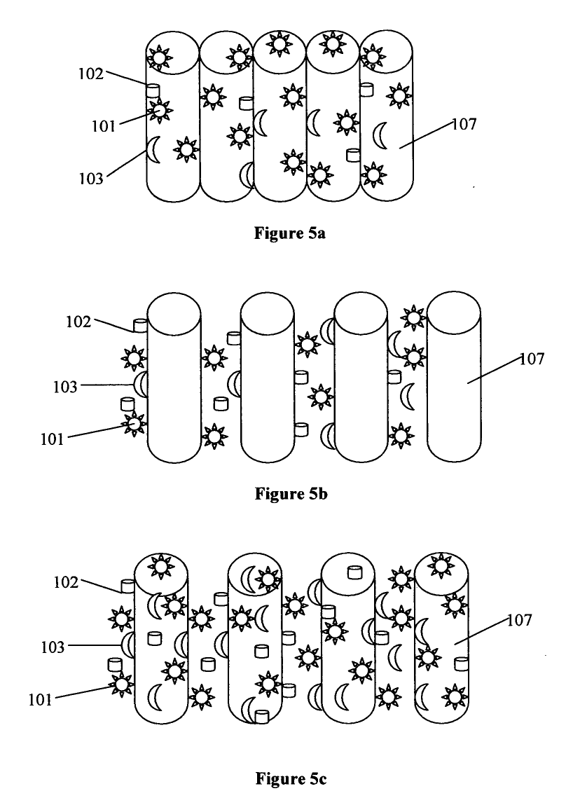

One of the embodiments of the invention proposes methods of changing nanostructure-fuel reactivity and other nanostructure properties by the presence of other nanostructures, for the purposes of enhancing the performance of the fuel cell. As is show in Figures 5a, 5b, and 5c, the nanostructure (for example, the carbon nanotube 107) has another nanostructure attached, the catalyst 101, to the inner walls or to the external walls, or to both the internal and external walls, respectively. Each configuration of attachments may induce different properties of the carbon nanotube including accelerated fuel movement, increased nanostructure-fuel reactivity, and enhanced storage capabilities of hydrogen or hydrocarbons, but are not limited to them.

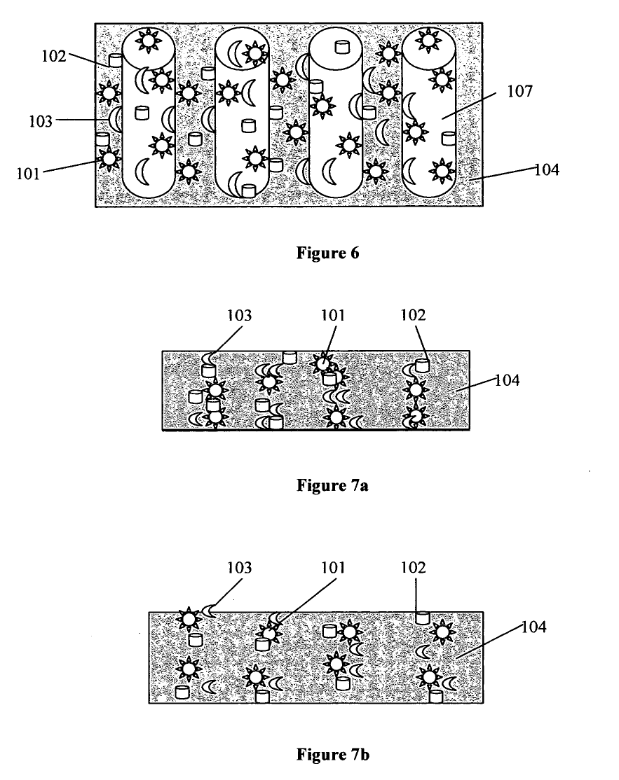

One of the designs of this invention also calls for embedding carbon nanotubes 107 into the electrodes (FIG. 6). The fuel delivered to the electrodes will move through carbon nanotube capillaries, and the catalysts 101 present inside the carbon nanotubes will effectively react with fuel and generate electrons, ions, and other reaction products. Carbon nanotubes may also accelerate the removal of reaction products providing space for new fuel molecules. Scenarios of utilizing capillaries or porous structures that are not built with carbon nanotube but with other nanostructures are also included in the invention. FIG. 7a and 7b show capillaries/porous structures built in the electrode based upon the random and predetermined distributions of the nanostructures. Although the preferable embodiments of this invention involve fuel movement through capillaries/porous nanostructures, the other shapes of nanostructures such as thin micro- and nano-films, nanowires, shells, and other differently shaped nanostructures are included in the invention.

Another embodiment of the invention is related to fuel cells in which there are embedded “nanometer range”-sized nanostructures. It is well known that such small-sized nanostructures have a total reaction surface area larger than the larger-sized structures. Thus, for equivalent weights of nanostructures, the “nanometer range”-sized nanostructures lead to higher reactivity with fuel. This effect allows a reduction in the amount of certain materials used in fuel cells, which is particularly important for fuel cells using expensive materials such as platinum. However, there exists a limit to how small materials can become and still remain useful in fuel cells.

Therefore, the invention proposes further improvements to fuel-nanostructure reactivity by utilizing in the proposed fuel cell nanotechnology effects such as surface plasmon resonance (SPR), electron-hole pair effects, and luminescence effects, but are not limited to them. The proposed effects increase fuel-nanostructure reactivity by several orders of magnitude and the previously mentioned surface area effect of shrinking the nanostructures to their physical limits to enhance reactivity with fuel will be less important. In order to take advantages of these effects in fuel cells, the nanostructures must be properly selected and especially designed. For example, nanostructures with sharp edges can generate with the internal and external energy sources SPR electromagnetic fields up to 10 microns from the nanostructures, and fuel within 10 microns from these nanostructures is greatly affected by the SPR electromagnetic fields leading to easier chemical breakdown and to the production of more electrons and ions.

The invention discloses a fuel cell in which the SPR electromagnetic fields in the nanostructures are induced by internal and/or external energy sources, and the nanostructure properties are designed to enhance the SPR interactions and other nanotechnology effects with the applied energy sources. For example, to effectively generate SPR electromagnetic fields in silver nanostructures or in gold nanostructures using light, silver nanostructures or gold nanostructures must be illuminated by blue or red light, respectively.

The invention also anticipates the use of nanostructures with a plurality of sizes in the proposed fuel cell. Nanostructures measuring one nanometer have different properties than those measuring 10-20 or 100 nanometers, even if they are made from the same material. Therefore, the proposed use of a plurality of sizes takes advantage of these nanotechnology effects. For example, the one nanometer-sized nanostructures may enhance SPR generation in the 10-20 nanometer-sized nanostructures by absorbing energy from electrochemical reactions and then emitting light which will be reabsorbed by the 10-20 nanometer-sized nanostructures. Another example describes a design of a fuel cell with a plurality of nanostructures in which some of the nanostructures are one nanometer carbon nanotubes.

The fuel flowing through or near the carbon nanotubes will generate not only electrons and ions, but also will induce electron-hole pairs in carbon nanotubes, which during recombination will produce luminescence. This luminescence can be used to generate SPR in the other nanostructures for the purpose of enhancing efficiency of the fuel cell. The luminescent wavelengths of carbon nanotubes can be tuned by their size to maximize fuel cell efficiency. Such a method can also be extended to other nanostructures and it is contemplated as a part of the invention.

The invention also considers SPR generation in the nanostructures by the electrochemical reactions occurring within the fuel cell or by other internal and/or external energy sources. The electrochemical reactions are associated with the generation of electromagnetic radiation and heat that can be used for SPR generation and other nanotechnology effects. The internal and/or external energy sources for SPR generation such as electromagnetic radiation, thermal, sonic, magnetic, and other energy sources can be powered by the fuel cell itself or by external sources, and are considered as a part of the invention.

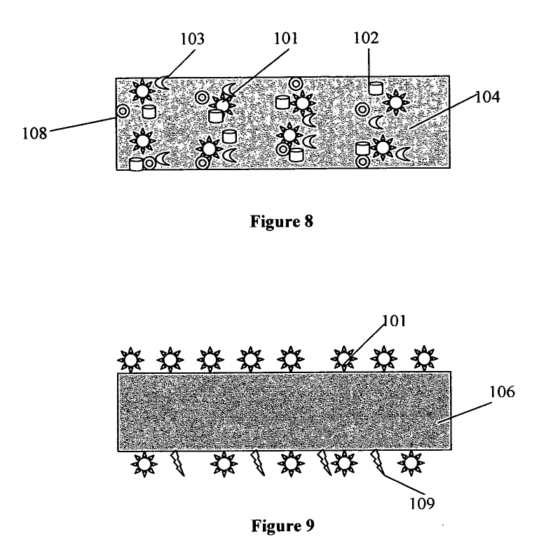

One of the embodiments of the invention proposes SPR generation at a reaction site where a luminescent probe 108 is also located (FIG. 8). The probe will enhance chemiluminescence from the electrochemical reactions by several orders of magnitude. The enhanced chemiluminescence will then be used to generate SPR in nanostructures.

The invention also discloses fuel cells in which SPR and nanotechnology effects are generated by the movement of fuel through the micro-/nano-porous/capillary structures of the electrodes. The interaction of fuels with such structures can be so intense as to even provide a separation of electrons and ions in water, which then can be used in the production of electricity in fuel cells. It is also proposed in the invention that an additional forcing of fuel movement through the structures by internal and/or external energy sources will further enhance electrochemical reactions in the fuel cells.

Another embodiment of the invention discloses the use the fuel enriched by the nanostructures. The enriching of fuels is particularly important for ethanol and higher order alcohols, but is not limited to them, where the “burning” processes of these fuels are usually incomplete. The colloidal nanostructures enriching the fuels can have catalytic/ionic/electron and other properties activated at the reaction side in the electrodes, where SPR and other nanotechnology effects are present.

The invention also describes improvements in the fuel cell related to fuel crossover through the membrane-electrolyte or related to excessive accumulation of the reaction products at a membrane-electrolyte site and the electrode sites. It is proposed to utilize the induced hydrophobicity and/or hydrophilicity by the nanostructures to mitigate these problems. One of the improvements of the fuel cell is shown in FIG. 9 where the nanostructures are covering an anode site and cathode site of a membrane 106. Each site is interacting with a different type of fuel. Therefore, the anode site can be, for example, covered with conductive nanostructures (catalyst 101) and the cathode site can be covered, for example, with a mixture of catalysts 101 and silicates 109. Because of the electric polarity between both sites of the membrane 106, the nanostructures will be SPR excited and create hydrophobic and/or hydrophilic spots on the membrane sites which help to reduce fuel crossover and/or excessive accumulation of the reaction products. FIG. 9 shows one of many possible designs of the embedded nanostructures in the membrane. There are many varieties of fuel cells, and for some of them, the embedded nanostructures in membranes should create hydrophilic conditions to minimize the evaporation of water from the membrane, and for some other fuel cells, the nanostructures should create hydrophobic conditions to move water away from the membranes. Both described cases and other possible cases using the nanostructures in the membranes and SPR effects are in the scope of the invention.

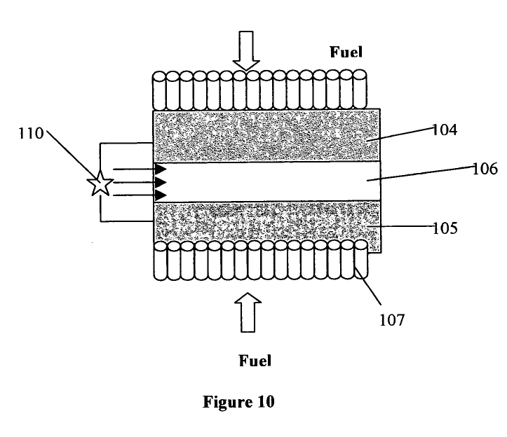

FIG. 10 shows a fuel cell in which an embedded plurality of nanostructures in a membrane 106 is illuminated by electromagnetic radiation (LED 110) that causes SPR and other effects generated in the membrane 106. The LED is powered by the fuel cell, however external energy sources can also be applied. This example of membrane illumination can be extended to the illumination of any component of the fuel cell and to the illumination of the fuel. The fuel can be used as a light guide to deliver light to the reaction sites in the fuel cell.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A fuel cell with an embedded plurality of nanostructures that interacts with a fuel or fuel product, wherein this interaction is stimulated or controlled by an energy source or a plurality of energy sources originating from the fuel cell or powered by external sources; wherein the nanostructures are positioned in the fuel cell at micro- to nano-proximities with respect to each other and the nanostructures properties are designed to enhance their interaction with the fuel or fuel product and with the energy source or with the plurality of energy sources.

2. The fuel cell of claim 1, wherein the embedded plurality of nanostructures is made from at least one of the materials selected from the group of materials: metallic electron conductive materials, non-metallic electron conductive materials, non-metallic semiconductive materials, non-metallic dielectric materials, ion conductive materials, silicates, carbon nanotubes, luminescent probe.

3. The fuel cell of claim 1, wherein the energy source or the plurality of energy sources are selected from the group of energy sources: electromagnetic, electric, electrostatic, sonic, magnetic, chemical, biochemical, electrochemical, thermal, mechanical.

4. The fuel cell of claim 3, wherein the electromagnetic source is a single or a plurality of electromagnetic sources selected from the group of: light emitting diodes, laser diodes, lamps, ionizing radiation, luminescence, chemiluminescence, bioluminescence, electroluminescence, fluorescence, phosphorescence.

5. The fuel cell of claim 1, wherein the embedded plurality of nanostructures has constant or varying concentrations of the nanostructures with respect to each other in at least one component of the fuel cell.

6. The fuel cell of claim 1, wherein the embedded plurality of nanostructures makes a porous structure and/or a capillary structure in at least one component of the fuel cell for the purposes of increased interactions with the fuel or fuel product.

7. The fuel cell of claim 1, wherein the embedded plurality of nanostructures has at least one function in the fuel cell selected from the group of: catalytical, ion conductive, electron conductive, hydrogen storage, delivering fuel, removing or adhering fuel products, current transfer from the fuel cell, reducing fuel cross-over, enhancing luminescence, enhancing plasmon generation, enhancing electron-hole pair generation.

8. The fuel cell of claim 7, wherein the function is stimulated or controlled by the energy source or the plurality of the energy sources.

9. The fuel cell of claim 7, wherein the function is modified by the presence of the other nanostructure in the fuel cell.

10. The fuel cell of claim 1, wherein the fuel used in the fuel cell is non-enriched by the nanostructures or enriched by the nanostructures.

11. The fuel cell of claim 10, wherein the fuel interacts with the embedded plurality of nanostructures and with the energy source or the plurality of the energy sources.

12. The fuel cell of claim 1, wherein the fuel or at least one component of the fuel cell serves in the fuel cell as an energy guide of the energy source or the plurality of the energy sources.

13. The fuel cell of claim 1, wherein the interaction of the embedded plurality of nanostructures with the fuel or fuel product is stimulated or controlled by at least one of the nanotechnology effects selected from the group of: surface plasmon resonance, electron-hole pair, luminescence.
